(19) United States
(12) Patent Application Publication
(10) Pub. No.: US 2026/0127434 A1
(43) Pub. Date: May 7, 2026

(54) ADAPTIVE NODE REMOVAL DURING TRAINING OF AN ARTIFICIAL NEURAL NETWORK

(71) Applicant: INTERNATIONAL BUSINESS MACHINES CORPORATION, Armonk, NY (US)

(72) Inventors: Kyong Min Yeo, Scarsdale, NY (US); Malgorzata Jadwiga Zimon, Warrington (GB); Fausto Martelli, Stockton Heath (GB); Bruce Gordon Elmegreen, Goldens Bridge, NY (US)

(21) Appl. No.: 18/936,416

(22) Filed: Nov. 4, 2024

(51) Int. Cl. G06N 3/082

(52) U.S. Cl. CPC G06N 3/082

(57) ABSTRACT

Systems, methods, and computer program products for adaptive node removal during training of an artificial neural network are described herein. A method comprises normalizing each weight of an artificial neural network; determining an entropy value for each node in the artificial neural network based on the weights of that node's connections; identifying a set of candidate nodes, the candidate nodes having the highest entropy value of their respective layers; selecting a subset of the set of candidate nodes; and removing, from the artificial neural network, each candidate node of the subset.

### BACKGROUND

Embodiments of the present disclosure relate to training artificial neural networks, and more specifically, to adaptive node removal during training of artificial neural networks.

### BRIEF SUMMARY

According to embodiments of the present disclosure, systems, methods of and computer program products for adaptive node removal during training of an artificial neural network are provided. A method for adaptive node removal during training of an artificial neural network may comprise normalizing each weight of an artificial neural network according to its neighborhood. The artificial neural network may comprise a plurality of nodes. The nodes may be organized into a plurality of layers. Each of the plurality of nodes may be connected to at least one node of at least one adjacent layer. Each connection may have an associated weight. The method may comprise determining an entropy value for each node in the artificial neural network based on the weights of that node's connections. The method may comprise identifying a set of candidate nodes. The set of candidate nodes may comprise a node of each layer having the highest entropy value of that layer. The method may comprise selecting a subset of the set of candidate nodes. Each candidate node of the subset may be connected to at least two other candidate nodes of the set. The method may comprise removing, from the artificial neural network, each candidate node of the subset.

### BRIEF DESCRIPTION OF THE DRAWINGS

FIG. 1 is a flow diagram depicting an exemplary method for adaptive node removal during training of an artificial neural network, in accordance with one or more embodiments of this disclosure.

FIGS. 2A, 2B, and 2C depict an exemplary artificial neural network at different stages of training, in accordance with one or more embodiments of this disclosure.

FIG. 3 depicts a computing node according to an embodiment of the present disclosure.

### DETAILED DESCRIPTION

An artificial neural network is a collection of one or more nodes. An artificial neural network is often divided into groups of nodes called layers. A layer is a collection of one or more nodes that all receive input from the same layer(s) and all send output to the same layer(s). The layer(s) from which the one or more nodes all receive input and the layer(s) to which the one or more nodes all send output are the adjacent, or neighboring, layers of the layer. Two nodes between which information flows (e.g., output of one node is sent to and received as input by the other node) are connected. Each connection may have an associated weight.

In some implementations, the associated weight of a connection may characterize the strength of the connection. A layer from which the one or more nodes all receive input is a preceding layer. A node's connection with a node of its preceding layer may be referred to as an incoming connection. A layer to which the one or more nodes all send output may be referred to as a following layer. A node's connection with a node of its following layer may be referred to as an outgoing connection.

An input layer is a layer that receives input from a source outside the artificial neural network. An output layer is a layer that sends output to a target outside the artificial neural network. All other layers are intermediate processing layers (i.e., hidden layers). A multilayer neural network is an artificial neural network with more than one layer. A deep neural network is a multilayer neural network with many layers.

A sparse neural network is an artificial neural network where a node is only connected to some (one or more) but not all nodes of its adjacent layer(s). In sparse neural networks, the information flow from the input layer to the output layer may be isolated and form paths.

A tensor is a multidimensional array of numerical values. A tensor block is a contiguous subarray of the elements in a tensor. Each neural network layer is associated with a parameter tensor V, weight tensor W, input data tensor X, output data tensor Y, and intermediate data tensor Z. The parameter tensor contains all parameters that control node activation functions σ in the layer. The weight tensor contains all weights that connect inputs to the layer. The input data tensor contains all data that the layer consumes as input. The output data tensor contains all data that the layer computes as output. The intermediate data tensor contains any data that the layer produces as intermediate computations, such as partial sums.

The data tensors (input, output, and intermediate) for a layer may be 3-dimensional, where the first two dimensions may be interpreted as encoding spatial location and the third dimension as encoding different features. For example, when a data tensor represents a color image, the first two dimensions encode vertical and horizontal coordinates within the image, and the third dimension encodes the color at each location. Every element of the input data tensor X can be connected to every node by a separate weight, so the weight tensor W generally has 6 dimensions, concatenating the 3 dimensions of the input data tensor (input row a, input column b, input feature c) with the 3 dimensions of the output data tensor (output row i, output column j, output feature k). The intermediate data tensor Z has the same shape as the output data tensor Y.

The parameter tensor V concatenates the 3 output data tensor dimensions with an additional dimension o that indexes the parameters of the activation function σ. In some embodiments, activation function σ requires no additional parameters, in which case the additional dimension is unnecessary. However, in some embodiments, activation function σ requires at least one additional parameter, which appears in dimension o. The activation function may be a linear activation function or a non-linear activation function. Activation functions that may be used by an artificial neural network as described herein may comprise sigmoid, tanh, ReLU, leaky ReLU, parametric ReLU, Softmax, and/or other activation functions. For example, an artificial neural network as described herein may have a tanh activation function.

An element of a layer's output data tensor Y can be computed as in Equation 1 where the node activation function σ is configured by the vector of activation function parameters V[i, j, k, :], and the weighted sum Z[i, j, k] can be computed as in Equation 2.

$$Y [ i , j , k ] = σ ( V [ i , j , k , : ] ; Z [ i , j , k ] ) \qquad ( Eqn . 1 )$$

$$Z [ i , j , k ] = {\sum }_{a = 1}^{A} {\sum }_{b = 1}^{B} {\sum }_{c = 1}^{C} W [ i , j , k , a , b , c ] \cdot X [ a , b , c ] \qquad ( Eqn . 2 )$$

For simplicity of notation, the weighted sum in Equation 2 may be referred to as the output, which is equivalent to using a linear activation function Y[i, j, k]=σ(Z[i, j, k])=Z[i, j, k], with the understanding that the same statements apply without loss of generality when a different activation function is used.

It will be apparent from the above that neural networks are parallel structures. Nodes in a given layer receive inputs, X with elements xᵢ, from one or more layers or other inputs. Each node computes its state, y∈Y based on the inputs and weights W with elements wᵢ. In various embodiments, the weighted sum of inputs is adjusted by a bias b, and then the result is passed to a nonlinearity F(·). For example, a single node activation may be expressed as y=F(b+Σxᵢwᵢ).

An artificial neural network may be trained to solve a specific problem (e.g., pattern recognition) by adjusting the weights of the connections such that a particular class of inputs produce a desired output. Various algorithms may be used for this learning process. Certain algorithms may be suitable for specific tasks such as image recognition, speech recognition, or language processing. Training algorithms lead to a pattern of weights that, during the learning process, converge toward an optimal solution to the given problem. The goal of such learning is to obtain a system that generalizes data unavailable during training.

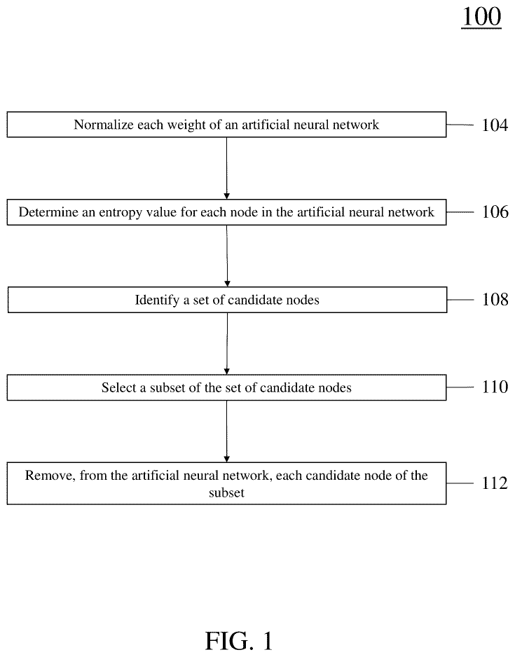

Referring now to FIG. 1 is a flowchart illustrating an exemplary method 100 for adaptive node removal during training of an artificial neural network. The operations of method 100 presented below are intended to be illustrative. In some implementations, method 100 is accomplished with one or more additional operations not described and/or without one or more of the operations discussed. The operations of method 100 may be performed in another order. Additionally, the order in which the operations of method 100 are illustrated in FIG. 1 and described below is not intended to be limiting.

In some implementations, method 100 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 100. In some implementations, the operations of method 100 are performed with regard to layers of an artificial neural network rather than individual nodes.

Operation 102 may comprise normalizing each weight of an artificial neural network according to its neighborhood. The neighborhood may comprise a layer, a forward/reverse connection, and/or another neighborhood of the weight. For example, each weight may be normalized relative to its layer. For example, each weight may be normalized relative to a forward/reverse connection. Responsive to the normalization of each weight, the weights within each neighborhood may sum to 1. The artificial neural network may comprise a plurality of nodes. The nodes may be organized into a plurality of layers. Each of the plurality of nodes may be connected to at least one node of at least one adjacent layer. Each connection may have an associated weight. The normalization of each weight may comprise applying min-max normalization to each weight.

Suitable artificial neural networks include but are not limited to a feed-forward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

In some implementations, the artificial neural network is a feed-forward neural network. The plurality of layers may comprise an input layer, an output layer, and at least one hidden layer. In some implementations, each node of the at least one hidden layer has at most four connections. In some implementations, each node of the input layer has at most one connection. In some implementations, each node of the output layer has at most as many connections as the number of nodes in the preceding layer.

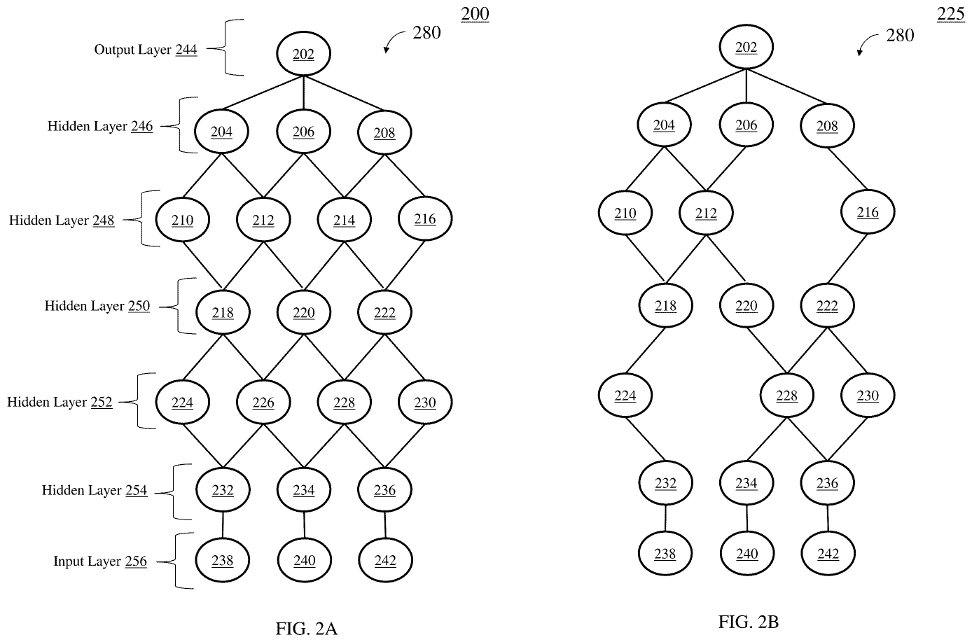

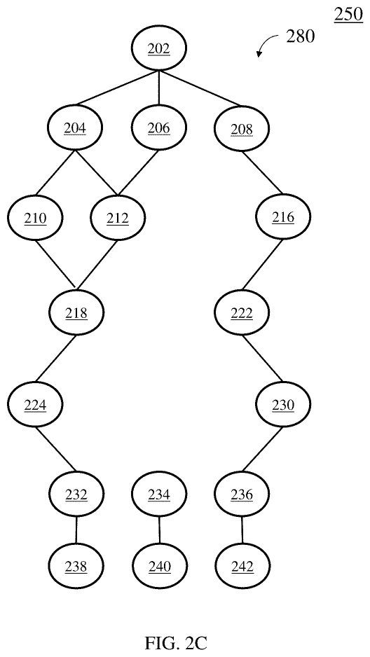

FIGS. 2A-2C depict artificial neural network 280 at different periods of training the artificial neural network 280. Artificial neural network 280 may be an artificial neural network suitable for adaptive node removal according to the methods described herein (e.g. method 100 described herein with reference to FIG. 1). Training the artificial neural network may comprise training the artificial neural network for a plurality of epochs. The artificial neural network may be trained until the artificial neural network reaches a predetermined error limit, for a predetermined number of epochs, for a predetermined amount of time, until a predetermined measure of energy used for training is reached, and/or until another limit is reached. During at least one of the epochs, adaptive node removal is performed on artificial neural network 280.

For example, adaptive node removal is performed after every k^{th} epoch of training artificial neural network 280. The number of epochs between each node removal may be chosen such that artificial neural network 280 stabilizes between node removals. In some implementations, adaptive node removal is only performed a predetermined number of times. For example, adaptive node removal is performed a total of 5 times. For further example, the adaptive node removal is performed every 10^{th} epoch for the first 50 epochs of training. Artificial neural network 280 may be trained for a total of 100 epochs. Artificial neural network 280 may be allowed to stabilize for the remaining 50 epochs of training.

For example, first period 200 reflects the first k epochs of training artificial neural network 280. As such, FIG. 2A depicts the nodes of artificial neural network 280 during the first k epochs of training. For example, second period 225 reflects the second k epochs of training artificial neural network 280. As such, FIG. 2B depicts the nodes of artificial neural network 280 during the second k epochs of training. For example, adaptive node removal was performed between first period 200 and second period 225. For example, third period 250 reflects, at least, the third k epochs of training artificial neural network 280. As such, FIG. 2C depicts the nodes of artificial neural network 280 during the third k epochs of training. For example, adaptive node removal was performed between second period 225 and third period 250.

Referring to FIG. 2A, an exemplary artificial neural network 280 during a first period 200 of training in accordance with one or more embodiments of the present disclosure is depicted. First period 200 may be a period prior to adaptive node removal being performed on artificial neural network 280. By way of non-limiting example, artificial neural network 280 is an untrained artificial neural network during first period 200.

Artificial neural network 200 may comprise nodes 202-242. Each of nodes 202-242 may be organized into one of input layer 256, hidden layer 252, hidden layer 254, hidden layer 252, hidden layer 250, hidden layer 248, hidden layer 246, and/or output layer 244. Nodes 238, 240, and 242 may be organized into input layer 256. Node 202 may be organized into output layer 244. Nodes 204, 206, and 208 may be organized into hidden layer 246. Nodes 210, 212, 214, and 216 may be organized into hidden layer 248. Nodes 218, 220, and 222 may be organized into hidden layer 250. Nodes 224, 226, 228, and 230 may be organized into hidden layer 252. Nodes 232, 234, and 236 may be organized into hidden layer 254.

Nodes 238, 240, and 240 may be connected to nodes 232, 234, and 236 respectively. As such, each node of the input layer has one connection during first period 200. Nodes 232, 234, 236 may each be connected to two nodes of hidden layer 252. Nodes 224, 226, 228, and 230 may each be connected to two nodes of hidden layer 254 and to two nodes of hidden layer 250. Nodes 218, 220, and 222 may each be connected to two nodes of hidden layer 242 and to two nodes of hidden layer 248. Nodes 210, 212, 214, and 216 may each be connected to two nodes of hidden layer 250 and to two nodes of hidden layer 246. Nodes 204, 206, and 208 may each be connected to two nodes of hidden layer 246 and to node 202. As such, each node of hidden layers 246, 248, 250, 252, and 254 may have at most four connections (at most two being connections with incoming nodes and at most two connections being with outgoing nodes). Each node of output layer 244 may have a connection to each node of hidden layer 246. As such, each node of output layer 244 may have as many connections as the number of nodes organized into hidden layer 246.

Referring back to FIG. 1, operation 104 may comprise determining an entropy value for each node in the artificial neural network based on the weights of that node's connections. The entropy value for a node may characterize a magnitude of information carried by the node. The information may be relevant to generation of an output by the artificial neural network. Determining an entropy value for a node of the artificial neural network may comprise determining the product of the normalized weights for all connections of the node. Determining the entropy value may comprise determining the logarithm of the product. Determining the entropy value may comprise determining the absolute value of the logarithm. For example, the entropy value for each node nₗ in layer l, may be represented by taking the normalized Nₙ_{ₗ} weights of incoming and outgoing connections,

$${w}_{i}^{{n}_{l}} ,$$

and computing the absolute value of the logarithm of their product. For example, the entropy value of a node can be represented as follows:

$$\vert log ( {\prod }_{i = 1}^{{N}_{{n}_{1}}} {w}_{i}^{{n}_{1}} ) \vert$$

Operation 106 may comprise identifying a set of candidate nodes. The set of candidate nodes may comprise a node of each layer having the highest entropy value of that layer, node(s) having an entropy value greater than or equal to a threshold entropy value, and/or other nodes. Accordingly, candidate nodes may be nodes having high entropy. Identifying the set of candidate nodes may comprise determining a current accuracy of the artificial neural network. The threshold entropy value may be determined based on the current accuracy of the artificial neural network. Determining the current accuracy may comprise comparing value(s) output by nodes of the output layer to an expected output. Identifying the set of candidate nodes may comprise determining the node with the highest entropy value in each layer.

Operation 108 may comprise selecting a subset of the set of candidate nodes. Each candidate node of the subset may be connected to at least two qualifying nodes of the set. A qualifying node may be a node included in the set of candidate nodes and/or a node having an entropy value of at least the threshold entropy value.

Operation 110 may comprise removing, from the artificial neural network, nodes of the artificial neural network. Removing the nodes may comprise removing one or more of each node of the subset of the set of candidate nodes, removing each orphan node, and/or removing one or more other nodes from the artificial neural network. Removing each orphan node may comprise identifying one or more orphan nodes. As used herein, anomalous nodes may be referred to as “orphan nodes.” An orphan node may be a node lacking any or certain connections according to the removal of the subset. For example, an orphan node is a node lacking all incoming connections or all outgoing connections according to the removal of the subset. For example, an orphan node is a node having no connections according to the removal of the subset. A node may be identified as an orphan node by virtue of only having incoming or outgoing connection(s) with candidate node(s). In some implementations, the one or more orphan nodes are identified after removal of each node of the subset. In such implementations, the one or more orphan nodes do not have any incoming connections and/or do not have any outgoing connections. Removing a node may comprise removing connections of the node with any other nodes of the artificial neural network.

Referring to FIG. 2B, artificial neural network 280 during a second period 225 of training in accordance with one or more embodiments of the present disclosure is depicted. Second period 225 may be a period of the training after a first performance of adaptive node removal. For example, nodes 202, 204, 214, 220, 226, 234, and/or 242 are identified as candidate nodes during the first performance of adaptive node removal. Node 214 may be included in the subset of the set of candidate nodes because its neighbor node 220 is a candidate node and its neighbor node 206 has an entropy value of at least a threshold entropy value. Node 226 may be included in the subset of the set of candidate nodes because its neighbor node 220 and its neighbor node 234 were identified as candidate nodes. Nodes 214 and 226 may be removed from artificial neural network 280 between first period 200 and second period 225. Accordingly, candidate nodes with at least two neighboring nodes also having high entropy are removed.

Referring to FIG. 2C, artificial neural network 280 during a third period 250 of training in accordance with one or more embodiments of the present disclosure is depicted. Third period 250 may be a period of the training after a second performance of adaptive node removal. For example, nodes 208, 210, 222, 228, and/or 234 are identified as candidate nodes during the second performance. Node 228 may be included in the subset of the set of candidate nodes because node 222 and node 234 were identified as candidate nodes. Node 220 may be identified as an orphan node by virtue of only having an incoming connection with node 228. For example, after removal of node 228, node 220 would not have any incoming connections. Nodes 220 and 228 may be removed from artificial neural network 280 between second period 225 and third period 250. The remaining nodes of artificial neural network 280 may form pathways of information flow via the remaining connections. During training of artificial neural network 280, nodes contributing the least to generation of the output by the model may be removed.

An experiment for testing the efficacy of training an artificial neural network in accordance with the adaptive node removal as described herein was conducted. For the experiment, a test artificial neural network was trained to recover the outputs of the following polynomial function:

$${\prod }_{i}^{8} ( {a}_{i} {θ}_{i}^{2} + 1 ) ,$$

where a=[0, 0, 1.15, 2.25, 0, 1.5, 0.9, 0]. Due to the coefficients, only the inputs θᵢ for i∈{3, 4, 6, 7} contribute to the training, while others do not influence the output. The inputs were treated as random variables θᵢ˜U(0, 1). The test artificial neural network was constructed with a suitable structure for node removal during training. The test artificial neural network was constructed using a sparse network with hyper-uniform connectivity. The test artificial neural network was constructed in accordance with one or more embodiments described in U.S. Patent Application Publication Number 2024/0202508, which is incorporated in its entirety herein. After every 10 epochs for the first 50 epochs, each weight was normalized, node entropy values were determined for each node of the test artificial neural network, and nodes with high entropy values were removed in accordance with the operations of method 100 depicted in FIG. 1. The test artificial neural network was trained for a total of 100 epochs using Tanh activation. After training, the test artificial neural network had 107 connections, a mean-squared error of 0.0056 and a relative error of 1.29%.

For comparison, a fully connected feed-forward network with one hidden layer was trained for 100 epochs using Tanh activation without the node removal. After training, the fully connected feed-forward network had 108 connections, a mean-squared error of 0.0201, and a relative error of 2.62%. For further comparison, an artificial neural network with the same starting structure as the test artificial neural network was trained for 100 epochs using Tanh activation without the node removal. After training, the artificial neural network had 176, connections, a mean-squared error of 0.0071, and a relative error of 1.45%.

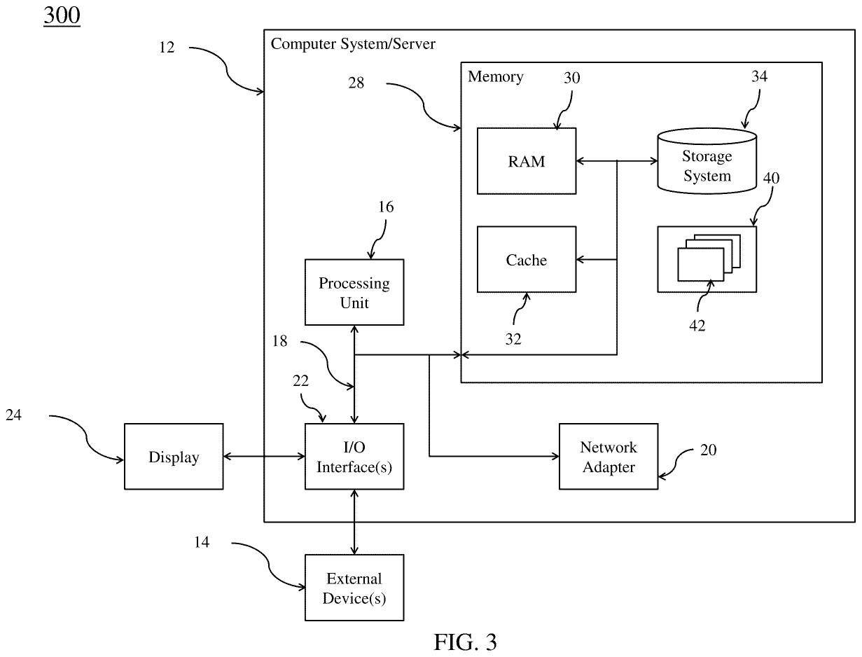

Referring now to FIG. 3, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for adaptive node removal during training of an artificial neural network, the method comprising:
normalizing each weight of an artificial neural network according to its neighborhood, the artificial neural network comprising a plurality of nodes, the nodes being organized into a plurality of layers, each of the plurality of nodes being connected to at least one node of at least one adjacent layer, wherein each connection has an associated weight;
determining an entropy value for each node in the artificial neural network based on the weights of that node's connections;
identifying a set of candidate nodes, wherein the set of candidate nodes comprises a node of each layer having the highest entropy value of that layer;
selecting a subset of the set of candidate nodes, wherein each candidate node of the subset is connected to at least two other candidate nodes of the set; and
removing, from the artificial neural network, each candidate node of the subset.

2. The method of claim 1, further comprising:
identifying one or more nodes lacking incoming connections and/or outgoing connections according to the removal of the subset; and
removing the one or more nodes from the artificial neural network.

3. The method of claim 1, wherein the artificial neural network is a feed-forward neural network.

4. The method of claim 1, wherein
the plurality of layers comprises an input layer, an output layer, and at least one hidden layer,
each node of the at least one hidden layer has at most four connections,
each node of the input layer has one connection, and
each node of the output layer has at most as many connections as the number of nodes in a preceding layer.

5. The method of claim 4, wherein each node of the at least one hidden layer has connections to at most two incoming nodes and to at most two outgoing nodes.

6. The method of claim 1, wherein the normalization of each weight comprises applying min-max normalization to each weight.

7. The method of claim 1, wherein the set of candidate nodes further comprises nodes having an entropy value of at least a threshold entropy value.

8. The method of claim 7, further comprising determining a current accuracy of the neural network, wherein the threshold entropy value is determined based on the current accuracy of the artificial neural network.

9. A method of training an artificial neural network, the method comprising:
training the artificial neural network for a plurality of epochs, wherein during at least one of the epochs, adaptive node removal is performed according to the method of claim 1.

10. A computer program product comprising:
one or more computer-readable storage media; and
program instructions stored on the one or more computer-readable storage media to perform operations comprising:
normalizing each weight of an artificial neural network according to its neighborhood, the artificial neural network comprising a plurality of nodes, the nodes being organized into a plurality of layers, each of the plurality of nodes being connected to at least one node of at least one adjacent layer, wherein each connection has an associated weight;
determining an entropy value for each node in the artificial neural network based on the weights of that node's connections;
identifying a set of candidate nodes, wherein the set of candidate nodes comprises a node of each layer having the highest entropy value of that layer;
selecting a subset of the set of candidate nodes, wherein each candidate node of the subset is connected to at least two other candidate nodes of the set; and
removing from the artificial neural network each candidate node of the subset.

11. The computer program product of claim 10, wherein the operations further comprise:
identifying one or more orphan nodes lacking incoming connections or outgoing connections according to the removal of the subset; and
removing the one or more orphan nodes from the artificial neural network.

12. The computer program product of claim 10, wherein
the plurality of layers comprises an input layer, an output layer, and at least one hidden layer,
each node of the at least one hidden layer has at most four connections,
each node of the input layer has one connection, and
each node of the output layer has at most as many connections as the number of nodes in a preceding layer.

13. The computer program product of claim 12, wherein each node of the at least one hidden layer has connections to at most two incoming nodes and to at most two outgoing nodes.

14. The computer program product of claim 10, wherein the normalization of each weight comprises applying min-max normalization to each weight.

15. The computer program product of claim 10, wherein the operations are performed during at least one epoch of training the artificial neural network, wherein the artificial neural network is trained for a plurality of epochs.

16. A computer system comprising:
a processor set;
one or more computer-readable storage media; and
program instructions stored on the one or more computer-readable storage media to perform operations comprising:
normalizing each weight of an artificial neural network according to its neighborhood, the artificial neural network comprising a plurality of nodes, the nodes being organized into a plurality of layers, each of the plurality of nodes being connected to at least one node of at least one adjacent layer, wherein each connection has an associated weight;
determining an entropy value for each node in the artificial neural network based on the weights of that node's connections;
identifying a set of candidate nodes, wherein the set of candidate nodes comprises a node of each layer having the highest entropy value of that layer;
selecting a subset of the set of candidate nodes, wherein each candidate node of the subset is connected to at least two other candidate nodes of the set; and
removing from the artificial neural network each candidate node of the subset.

17. The computer system of claim 16, wherein the operations further comprise:
identifying one or more orphan nodes lacking incoming connections or outgoing connections according to the removal of the subset; and
removing the one or more orphan nodes from the artificial neural network.

18. The computer system of claim 16, wherein
the plurality of layers comprises an input layer, an output layer, and at least one hidden layer,
each node of the at least one hidden layer has at most four connections,
each node of the input layer has at most two connections, and
each node of the output layer has at most as many connections as the number of nodes in a preceding layer.

19. The computer system of claim 18, wherein each node of the at least one hidden layer has connections to at most two incoming nodes and to at most two outgoing nodes.

20. The computer system of claim 16, wherein the operations are performed during at least one epoch of training the artificial neural network, wherein the artificial neural network is trained for a plurality of epochs.
